(19) United States
(12) Patent Application Publication
(10) Pub. No.: US 2011/0014965 A1
(43) Pub. Date: Jan. 20, 2011

(54) GAMING MACHINE AND CONTROL METHOD THEREOF

(75) Inventor: Yukinori INAMURA, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: UNIVERSAL ENTERTAINMENT CORPORATION, Koto-ku (JP); Aruze Gaming America, Inc., Las Vegas, NV (US)

(21) Appl. No.: 12/820,490

(22) Filed: Jun. 22, 2010

(30) Foreign Application Priority Data
Jul. 15, 2009 (JP) 2009-167200

(51) Int. Cl. A63F 9/24; A63F 13/00

(52) U.S. Cl. 463/20; 463/30; 463/43

(57) ABSTRACT

The present invention provides a gaming machine allowing a player to make more BET operations spontaneously is provided. This gaming machine includes processing of: in a case where the input number of BETs is a first number of BETs, display the specific symbol combination on the display more frequently than when a second number of BETs is placed; and disabling awarding of a payment of a prize even if a specific symbol combination is rearranged on a display; in a case where the input number of BETs is a second number of BETs, displaying the specific symbol combination on the display less frequently than when the first number of BETs is placed; and awarding the payment of the prize in a case where the specific symbol combination is rearranged on the display.

### CROSS-REFERENCE TO RELATED APPLICATIONS

This application is based on and claims a priority from the prior Japanese patent Application No. 2009-167200 filed on Jul. 15, 2009, the entire contents of which are incorporated herein by reference.

### BACKGROUND OF THE INVENTION

1. Field of the Invention

The present invention relates to a gaming machine and its control method, and in particular to a gaming machine and its control method, which is capable of causing a player to perform a plenty of BET operations spontaneously.

2. Description of the Related Art

Conventionally, in gaming machines, symbols are displayed by employing virtual reels displayed on liquid crystal displays, and prizes are paid out in accordance with a combination or the like of rearranged symbols. In addition, in the conventional gaming machines, arrangements of the symbols displayed on the virtual reels are of the same kind, irrespective of whatsoever the number of coins or the like betted by players may be. The players input only their desired number of BETs; and therefore, the profits obtained by the gaming machines from the player' s BETs are passive. One example of such gaming machines is disclosed in U.S. Pat. No. 6,394,902B1.

The present invention provides a gaming machine and its control method allowing a player to spontaneously perform a variety of BET operations, which has not been achieved by the above-described related art.

### SUMMARY OF THE INVENTION

A first aspect of the present invention is directed to a gaming machine, comprising:
(i) an input device for inputting a number of BETs;
(ii) a memory for storing plural kinds of symbols for displaying plural kinds of symbol combinations including a specific symbol combination which is not paid when a first number of BETs is placed and which is paid when a second number of BETs is placed;
(iii) a display for displaying the plural kinds of symbols; and
(iv) a controller, the controller being configured to perform processing of:

(a-1) in a case where the number of BETs input by the input device is the first number of BETs, determining arrangement of the plural kinds of symbols so that the specific symbol combination is displayed on the display more frequently than when the second number of BETs is placed;

(a-2) rearranging the plural kinds of symbols on the display in accordance with a result of the determination of (a-1);

(a-3) awarding a payment-free prize is made, in a case where the specific symbol combination is rearranged on the display as a result of the processing of (a-2);

(b-1) in a case where the number of BETs input by the input device is the second number of BETs, determining arrangement of the plural kinds of symbols so that the specific symbol combination is displayed on the display less frequently than when the first number of BETs is placed;

(b-2) rearranging the plural kinds of symbols on the display in accordance with a result of the determination of (b-1); and

(b-3) awarding a payment-accompanying prize in a case where the specific symbol combination is rearranged on the display as a result of the processing of (b-2).

According to the first aspect of the present invention, a payment-accompanying symbol is rearranged at a high probability due to a player's BET amount, and a specific symbol combination is displayed. However, in a case where the specific symbol combination is displayed at the high probability, the player cannot obtain a payment according to the specific symbol combination, and feels a sense of loss due to the fact that he or she has let a payment slip away. This enables the player to change the amount of BETs by his or her intention.

A second aspect of the present invention is directed to the gaming machine of the first aspect, wherein the first number of BETs is smaller than the second number of BETs.

According to the second aspect of the present invention, when a player has played a game by placing a small number of BETs, a payment-accompanying symbol only when a large number of BETs is placed is rearranged at a high probability. If the player has repeatedly played games by placing a small number of BETs, he or she lets a payment slip away, which could be obtained if a large number of BETs is placed a plenty of times, and then, feels a sense of loss. Therefore, the player seeks to place a large number of BETs by his or her intention, and the amount of BETs in one game can be increased.

A third aspect of the present invention is directed to the gaming machine of the first aspect, wherein the specific symbol combination is paid when the second number of BETs is placed and is paid also when a third number of BETs, which is larger than the first number of BETs and smaller than the second number of BETs, is placed, the controller being configured to perform processing of:

(c-1) in a case where the number of BETs input by the input device is the third number of BETs, determining arrangement of the plural kinds of symbols so that the specific symbol combination is displayed on the display less frequently than when the first number of BETs is placed and is displayed more than that when the second number of BETs is placed;

(c-2) rearranging the plural kinds of symbols on the display in accordance with a result of the determination of (c-1); and

(c-3) awarding the payment-accompanying prize in a case where the specific symbol combination is rearranged on the display as a result of the processing of (c-2).

According to the third aspect of the present invention, a third number of BETs is further provided between a first number of BETs and a second number of BETs, and even if a game is played by placing the third number of BETs, a payment due to a specific symbol combination can be obtained. Therefore, a player can easily change the number of BETs by his or her intention.

A fourth aspect of the present invention is directed to a gaming machine, comprising:

an input device for inputting a number of BETs;
(i) a memory for storing plural kinds of symbols for displaying plural kinds of symbol combinations including a specific symbol combination which is not paid when a first number of BETs is placed and which is paid when a second number of BETs, which is larger than the first number of BETs, and a third number of BETs, which is smaller than the second number of BETs and larger than the first number of BETs, is placed;
(ii) a display for displaying the plural kinds of symbols; and
(iii) a controller, the controller being configured to perform processing of:

(a-1) in a case where the number of BETs input by the input device is the first number of BETs, determining arrangement of the plural kinds of symbols so that the specific symbol combination is displayed on the display more frequently than when the second number of BETs is placed;

(a-2) rearranging the plural kinds of symbols on the display in accordance with a result of the determination of (a-1);

(a-3) awarding a payment-free prize in a case where the specific symbol combination is rearranged on the display as a result of the processing of (a-2);

(b-1) in a case where the number of BETs input by the input device is the second number of BETs, determining arrangement of the plural kinds of symbols so that the specific symbol combination is displayed on the display less frequently than when the first number of BETs is placed;

(b-2) rearranging the plural kinds of symbols on the display in accordance with a result of the determination of (b-1);

(b-3) awarding a payment-accompanying prize in a case where the specific symbol combination is rearranged on the display as a result of the processing of (b-2);

(c-1) in a case where the number of BETs input by the input device is the third number of BETs, determining arrangement of the plural kinds of symbols so that the specific symbol combination is displayed on the display less frequently than when the first number of BETs is placed and is displayed more than when the second number of BETs is placed;

(c-2) rearranging the plural kinds of symbols on the display in accordance with a result of the determination of (c-1); and

(c-3) awarding the payment-accompanying prize in a case where the specific symbol combination is rearranged on the display as a result of the processing of (c-2).

According to the fourth aspect of the present invention, when a player has played a game by placing small number of BETs, a payment-accompanying symbol only when a large number of BETs is placed is rearranged at a high probability. If the player has repeatedly played games by placing a small number of BETs, he or she lets a payment slip away, which could be obtained if a large number of BETs is placed a plenty of times, and then, feels a sense of loss. In addition, since a payment due to a specific symbol combination can be obtained merely by increasing a small amount of BETs, the player seeks to place a large number of BETs by his or her own intention, and the amount of BETs in one game can be increased.

A fifth aspect of the present invention is directed to a gaming machine control method, comprising the steps of:

(a-1) in a case where the number of BETs input by the input device is the first number of BETs, determining arrangement of the plural kinds of symbols so that the specific symbol combination is displayed on the display more frequently than when the second number of BETs is placed;

(a-2) rearranging the plural kinds of symbols on the display in accordance with a result of the determination of (a-1);

(a-3) awarding a payment-free prize is made, in a case where the specific symbol combination is rearranged on the display as a result of the processing of (a-2);

(b-1) in a case where the number of BETs input by the input device is the second number of BETs, determining arrangement of the plural kinds of symbols so that the specific symbol combination is displayed on the display less frequently than when the first number of BETs larger than the first number of BETs is placed;

(b-2) rearranging the plural kinds of symbols on the display in accordance with a result of the determination of (b-1); and

(b-3) awarding a payment-accompanying prize in a case where the specific symbol combination is rearranged on the display as a result of the processing of (b-2).

According to the fifth aspect of the present invention, when a player has played a game by placing a small number of BETs, a payment-accompanying symbol only when a large number of BETs is placed is rearranged at a high probability. If the player has repeatedly played games by placing a small number of BETs, he or she lets a payment slip away, which could be obtained if a large number of BETs is placed a plenty of times, and then, feels a sense of loss. Therefore, the player seeks to place a large number of BETs by his or her intention, and the amount of BETs in one game can be increased.

A sixth aspect of the present invention is directed to the gaming machine control method of the fifth aspect, wherein the specific symbol combination is paid when the second number of BETs is placed, and is paid when a third number of BETs, which is larger than the first number of BETs and is smaller than the second number of BETs, is placed, the method further comprising the steps of:

(c-1) in a case where the number of BETs input by the input device is the third number of BETs, determining arrangement of the plural kinds of symbols so that the specific symbol combination is displayed on the display less frequently than when the first number of BETs is placed and is displayed more frequently than when the second number of BETs is placed;

(c-2) rearranging the plural kinds of symbols on the display in accordance with a result of the determination of (c-1); and

(c-3) awarding the payment-accompanying prize in a case where the specific symbol combination is rearranged on the display as a result of the processing of (c-2).

According to the sixth aspect of present invention, a third number of BETs is provided between a first number of BETs and a second number of BETs, and even if a game is played by placing the third number of BETs, a payment due to a specific symbol combination can be obtained. Therefore, a player can easily change the number of BETs by his or her intention.

According to the present invention, a gaming machine and its control method allowing a player to perform a plenty of BET operations spontaneously can be provided.

### BRIEF DESCRIPTION OF THE DRAWINGS

FIG. 1 is a flowchart showing a subroutine of basic game processing;

FIG. 2 is an explanatory view of a scatter prize payment table;

FIG. 3 is an explanatory view of the number of symbols, respectively, included in a symbol arrangement table;

FIG. 4 is a perspective view showing an appearance of a gaming machine;

FIG. 5 is an explanatory view of a scatter prize payment table;

FIG. 6 is an explanatory view of the number of symbols, respectively, included in a symbol arrangement table;

FIG. 7 is a view showing a symbol arrangement table at the time of 2-BETs;

FIGS. 8A and 8B are views each showing an exemplary image displayed on a lower image display panel while in a basic game;

FIG. 9 is a block diagram depicting an internal configuration of a gaming machine;

FIG. 10 is a flowchart showing a routine of main processing;

FIG. 11 is a flowchart showing a subroutine of insurance selection processing;

FIG. 12 is a flowchart showing a subroutine of coin insertion/start check processing;

FIG. 13 is a flowchart showing a subroutine of jackpot-related processing;

FIG. 14 is a flowchart showing a subroutine of insurance-related processing;

FIG. 15 is a flowchart showing a subroutine of symbol determination processing;

FIG. 16 is a flowchart showing a subroutine of symbol rearrangement processing;

FIG. 17 is a flowchart showing a subroutine of number-of-payouts determination processing;

FIG. 18 is a flowchart showing a subroutine of free game processing;

FIG. 19 is a flowchart showing a subroutine of insurance check processing.

### DESCRIPTION OF THE PREFERRED EMBODIMENTS

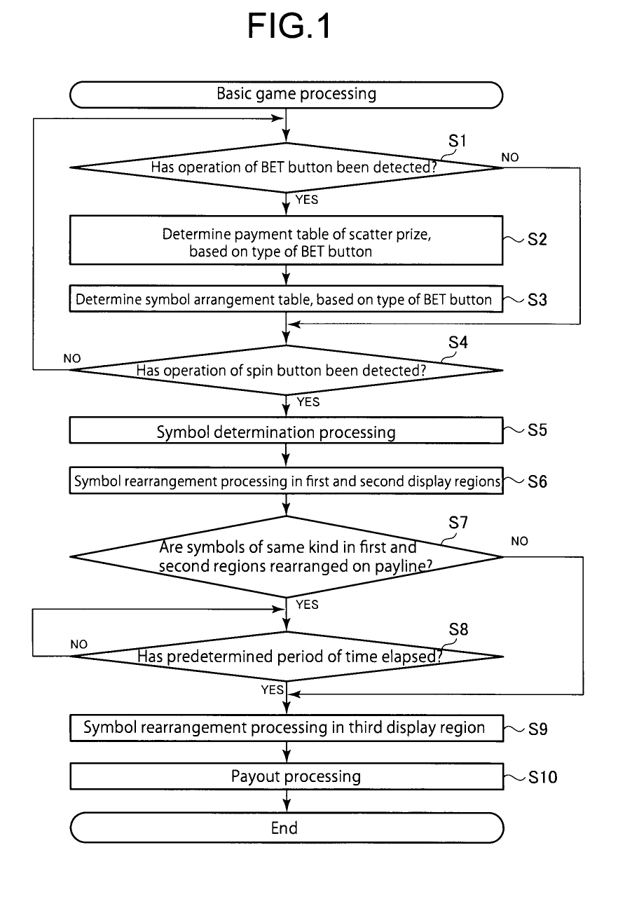

Hereinafter, embodiments of the present invention will be described referring to the drawings. FIG. 1 is a flowchart showing a subroutine of basic game processing.

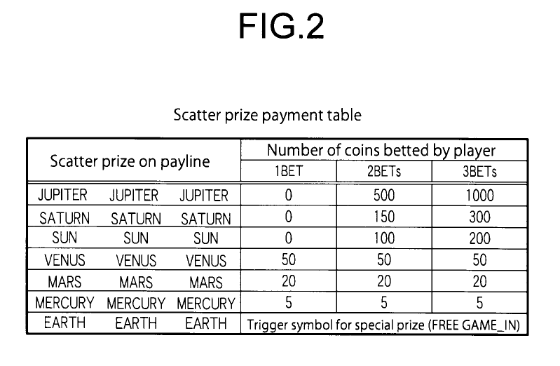

First, a main CPU 71 included in a gaming machine 1 which is a gaming machine of the embodiment determines a scatter prize payment table in accordance with the number of coins betted by a player (hereinafter, a term “step” is abbreviated as “S”, for example, S1 or S2). In this processing, the main CPU 71 is stored in a RAM 73, and determines a payment table in accordance with the number of coins betted by a player, from a scatter prize payment table shown in FIG. 2. In the scatter prize payment table of the embodiment, no payment is made even at a time when three “JUPITER” symbols, three “SATURN” symbols, or three “SUN” symbols are rearranged when a basic game is started by a player having placed 1-BET. Alternatively, a predetermined payment is made if one of the above symbol combinations is established when a basic game is played by a player having placed 2-BETs or 3-BETs.

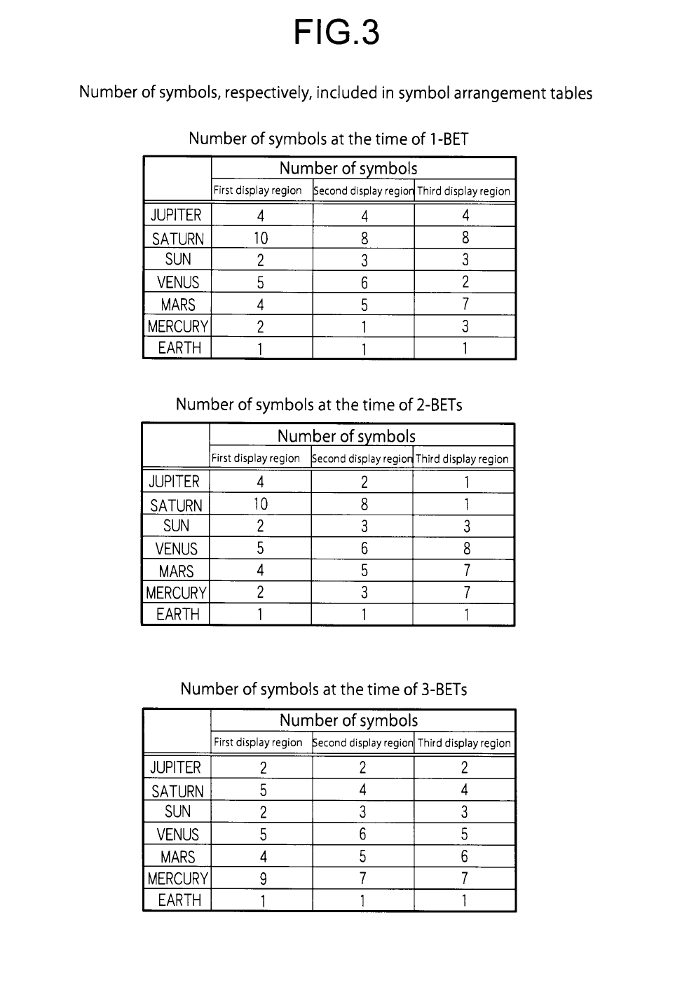

Next, the main CPU 71 determines a symbol arrangement table in accordance with the number of coins betted by a player (S3). In this processing, the main CPU 71 determines a table in accordance with the number of coins betted by a player, from three symbol arrangement tables stored in association with the number of BETs in the RAM 73. The three symbol arrangement tables include a different number of symbols, respectively, included in symbol arrangement in accordance with the number of BETs, as shown in FIG. 3. For example, the symbol arrangement at the time of 1-BET includes more “JUPITER” and “SATURN” symbols. Therefore, when a basic game is started by a player having placed 1-BET, more “JUPITER” and “SATURN” symbols are rearranged in display blocks 28. In addition, at the time of 2-BETs, more “JUPITER” and “SATURN” symbols are included in a first display region, which is a left-side column of the display blocks 28, and a second display region, which is a central column thereof, whereas these symbols are less included in a third display region which is a right-side column. Therefore, the JUPITER” and “SATURN” symbols are hardly rearranged in the third display region.

Next, upon detecting an operation of a spin button by a player, the main CPU 71 determines a mode of rearrangement of symbols to be stop-displayed (rearranged) in the display blocks 28 (S4, S5). Afterwards, the main CPU 71 rearranges symbols in sequential order of the first and second display regions (S6). These symbols are sequentially rearranged in the first to third display regions, respectively, so that a player can enjoy a game while keeping track of the process of establishment of a scatter prize.

Next, in the case where symbols of same kinds are rearranged on paylines of the first and second display regions, symbols are rearranged by the main CPU 71 in the second display region, and thereafter, the third display region is scroll-displayed until a predetermined period of time has elapsed (S7, S8). After the predetermined period of time has elapsed, the main CPU 71 rearranges symbols in the third display region (S9). When a combination of the symbols that are rearranged on the payline corresponds to a payout-accompanying scatter prize specified in the scatter prize payment table determined in S2, the main CPU 71 makes a predetermined payout (S10).

As described above, according to the present invention, when a basic game is played by a player having placed 1-BET, symbols having a payment made only when 2-BETs or 3-BETs are placed are rearranged at a high probability on a payline. Therefore, if a basic game is repeatedly played by 1-BET, the player lets a payment slip away, which could be obtained if 2-BETs or 3-BETs are placed, and then, feels a sense of loss. Accordingly, the player seeks to place 2-BETs or 3-BETs by his or her own intention in order to gain a payment of the scatter prize of “JUPITER”, “SATURN”, and “SUN” symbols, increasing a BET amount in one game to be obtained by a gaming machine.

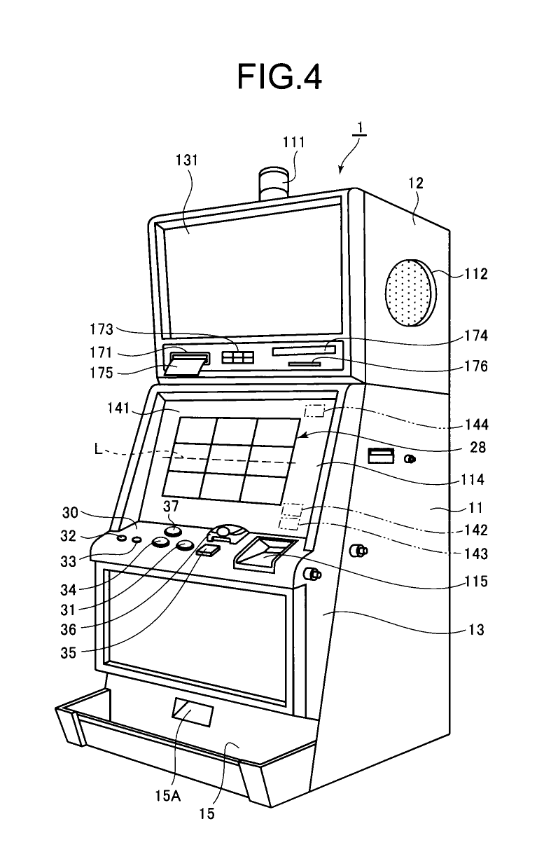

Next, a configuration of each of the gaming machines 1 in the embodiment will be described. FIG. 4 is a perspective view showing an appearance of the gaming machine.

A coin, a bill, or electrically valuable information corresponding to these is used as a game medium in the gaming machine 1. Further, in the present embodiment, a later-described ticket with a barcode is also used. It is to be noted that the game medium is not limited to these, and for example a medal, a token, electric money or the like can be adopted.

The gaming machine 1 includes a cabinet 11, a top box 12 installed on the upper side of the cabinet 11, and a main door 13 provided at the front face of the cabinet 11.

A lower image display panel 141 is provided at the center of the main door 13. The lower image display panel 141 is provided with a transparent liquid crystal panel, and nine display blocks 28 of 3 columns×3 lines are displayed. One symbol is displayed in each of these display blocks 28. A payline L is then set in a horizontal direction so as to pass through the center of the display blocks 28. The lower image display panel 141 corresponds to a display according to the present invention.

In addition, a number-of-credits display portion 142, a number-of-payouts display portion 143, and a number-of-BETs display portion 144 are set on the lower image display panel 141. At the number-of-credits display portion 142, the number of credited coins is displayed by means of image. At the number-of-payouts display portion 143, the number of coins to be paid out in the case where a predetermined number or more of symbols of same kinds have been stop-displayed on the payline L is displayed by means of image. At the number-of BETs display portion 144, the number of coins betted by a player for a basic game is displayed by means of image.

A touch panel 114 is provided on the front face of the lower image display panel 141. A player can input various commands by operating the touch panel 114.

Those provided on the lower side of the lower image display panel 141 are: a control panel 30 made of a plurality of buttons 31 to 35 by which a player inputs a command related to the progress of a game; a coin accepting slot 36 for accepting a coin in the cabinet 11; and a bill validator 115.

A spin button 31, a change button 32, a CASHOUT button 33, a 1-BET button 34, a maximum BET button 35, and an insurance-BET button 37 are provided on the control panel 30. The spin button 31 is for inputting a command of starting scroll-display of symbols. The CHANGE button 32 is employed when requesting a game facility staff to exchange money. The CASHOUT button 33 is used when paying out the credited coins to a coin tray 15.

The 1-BET button 34 is for inputting a command of inserting one of the credited coins for the play of a game. In addition, when the 1-BET button 34 is operated twice, two coins are inserted for the play of a game. The maximum-BET button 35 is for inputting a command of inserting a maximum number of the credited coins, which can be inserted in one game (three coins in the embodiment), for the play of the game. The 1-BET button 34 and the maximum-BET button 35 are BET buttons for starting a game.

The insurance-BET button 37 is for inputting a command of inserting a predetermined number of coins (one coin, for example) in order to make an insurance function effective. Unlike the BET buttons 34, 35, a player arbitrarily performs insertion to make the insurance function effective by means of the insurance-BET button 37. In the embodiment, the insurance-BET button 37 is operated, whereby an insurance of $1.00 is subtracted from the credits stored in the RAM 73 on a game-by-game basis.

The bill validator 115 is provided to validate whether or not to accept a bill. The bill validator 115 validates whether or not a bill is valid, and accepts the valid bill in the cabinet 11. The bill validator 115 may be configured so as to be able to read a ticket 175 with a barcode, to be described later.

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. Further, the top box 12 is provided with a speaker 112 and a lamp 111. The gaming machine 1 produces effects by displaying images, outputting sounds, and outputting the light.

A ticket printer 171, a card slot 176, a data display 174, and a keypad 173 are provided on the lower side of the upper image display panel 131.

The ticket printer 171 prints on a ticket a barcode representing encoded data of the number of credits, date, the identification number of the gaming machine 1, and the like, and outputs the ticket as the ticket 175 with a barcode. The player can make a gaming machine read the ticket 175 with a barcode so as to play a game thereon, and can also exchange the ticket 175 with a barcode with a bill or the like at a predetermined place (e.g. a cashier in a casino) in the game facility.

The card slot 176 is for inserting a card in which predetermined data is stored. For example, the card stores data for identifying the player, and data about the history of games played by the player.

When the card is inserted into the card slot 176, a later-described card reader 172 reads data from the card or writes data into the card. It is to be noted that the card may store data corresponding to a coin, a bill or a credit.

The data display 174 includes a fluorescent display, LEDs and the like, and displays the data read by the card reader 172 or the data inputted by the player via the keypad 173, for example. The keypad 173 is for inputting a command and data related to ticket issuance or the like.

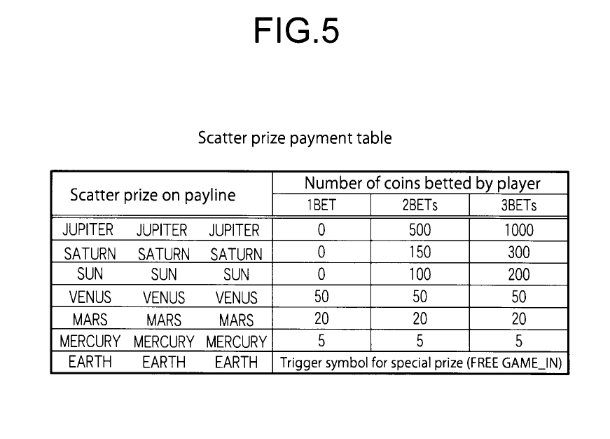

Next, a scatter prize as a winning combination will be described. FIG. 5 is an explanatory view of a scatter prize payment table. FIG. 5 is the same as FIG. 2. “JUPITER”, “SATURN”, “SUN”, “VENUS”, “MARS”, “MERCURY”, and “A” symbols are trigger symbols for scatter prize. Of these symbols, if three symbols of same kind are stop-displayed (rearranged) on the payline L of the lower image display panel 141, based on this table, a predetermined number of coins are paid out as a scatter prize in accordance with the kind and number of symbols and the number of BETs. For example, if three “JUPITER” symbols are stop-displayed on the payline L, no coins are paid out at the time of 1-BET of the first number of BETs, 500 coins are paid out at the time of 2-BETs of the three number of BETs, or 1,000 coins are paid out at the time of 3-BETs of the second number of BETs. In addition, if three “SATURN” symbols are stop-displayed on the payline L, no coins are paid out at the time of 1-BET of the first number of BETs, 150 coins are paid out at the time of 2-BETs of the three number of BETs, or 3000 coins are paid out at the time of 3-BETs of the second number of BETs.

Hereinafter, an “EARTH” symbol will be described. The “EARTH” symbol is a trigger symbol for free game. If three “EARTH” symbols are stop-displayed (rearranged) on the payline L of the lower image display panel 141, a free game is started. If three “A” symbol is stop-displayed (rearranged) on the payline L of the lower image display panel 141, a jackpot-related processing is started.

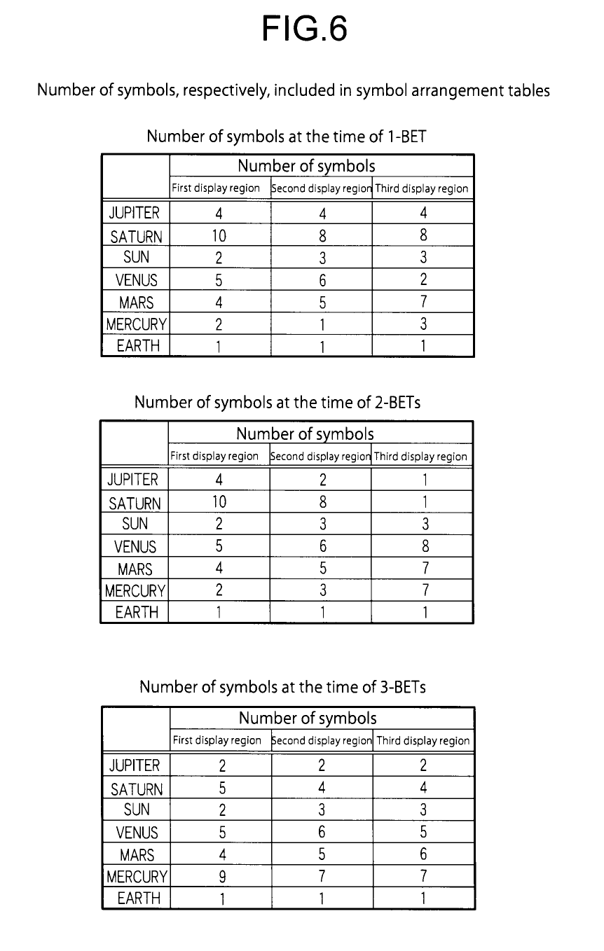

Next, the number of symbols, respectively, included in a symbol arrangement table, will be described. FIG. 6 is an explanatory view of the number of symbols, respectively, included in a symbol arrangement table. FIG. 6 is the same as FIG. 3. In the embodiment, three symbol arrangement tables corresponding to the number of coins to be betted by a player are stored in the RAM 73.

The symbol arrangement table at the time of 1-BET includes more “JUPITER” and “SATURN” symbols over all display regions. Therefore, when a basic game is played by a player having placed 1-BET, more “JUPITER” and “SATURN” symbols are rearranged at a high probability on the display blocks 28. However, among the “JUPITER”, and “SATURN” symbols, even if three symbols of same kind are rearranged on the payline L at the time of 1-BET, no payment is made (see FIG. 5). Therefore, Therefore, if a basic game is repeatedly played by 1-BET, the player lets a payment slip away, which could be obtained if 2-BETs or 3-BETs are placed, and then, feels a sense of loss.

At the time of 2-BETs, more “JUPITER” and “SATURN” symbols are arranged in the first and second display regions. However, these symbols are less arranged in the third display region. Therefore, a player expects a relevant payment from an appearance that “JUPITER” or “SATURN” symbols are frequently rearranged on the payline of the first and second display regions. Accordingly, the player becomes likely to have high expectation for a possibility that the scatter prize due to a winning combination of the “JUPITER” or “SATURN” symbols will be established in the near future as a basic game is played at 2-BETs a plenty of times; and consequently, the player seeks to place 3-BETs by his or her intention.

At the time of 3-BETs, symbols are set in such a manner that not so many “JUPITER” or “SATURN” symbols are rearranged at a high probability. Tha number of symbols are similar to that in the conventional gaming machines.

Accordingly, the input number of BET is at the time of 1-BET, display the specific symbol combination on the lower image display panel 141 more frequently than when the time of 3-BETs is placed at the time of 1-BET. Further, the input number of BET is at the time of 2-BETs, display the specific symbol combination on the lower image display panel 141 more frequently than when the time of 3-BETs is placed at the time of 2-BETs. And at the time of 2-BETs, display the specific symbol combination on the lower image display panel 141 smaller than when the time of 1-BET is placed at the time of 2-BETs.

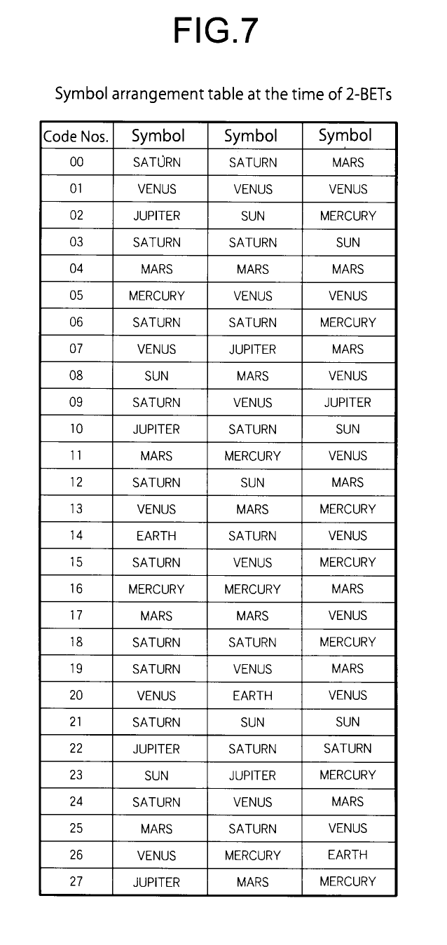

Next, a symbol arrangement table will be described. FIG. 7 is a view showing a symbol arrangement table at the time of 2-BETs. As shown in FIG. 7, columns of 28 symbols made of code numbers 00 to 27 are scroll-displayed in display blocks 28. Each column of symbols are comprised of a combination of “EARTH”, “JUPITER”, “SATURN”, “SUN”, “VENUS”, “MARS”, and “MERCURY” symbols. These symbols are all scatter symbols.

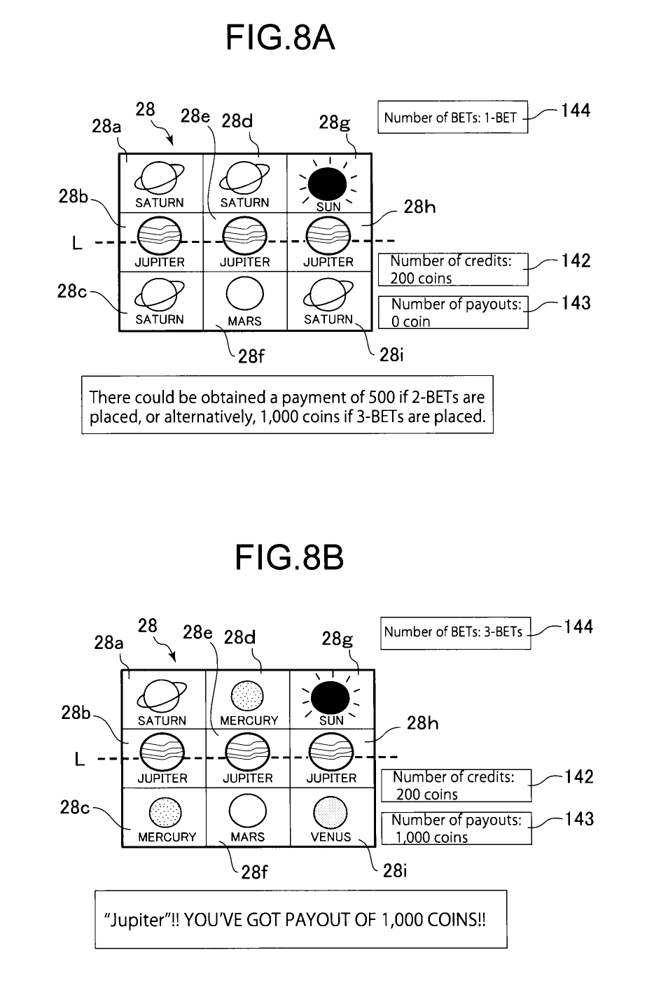

Next, an image to be displayed on the lower image display panel 141 will be described. As shown in FIG. 8A, the display blocks 28 are displayed on the lower image display panel 141. In the display blocks 28, a payline L is set horizontally from the left to the right. The display blocks 28a to 28c correspond to the first display region; the display blocks 28d to 28f correspond to the second display region; and the display blocks 28g to 28i correspond to the third display region. The figure also shows a case in which a player has played a basic game by operating the 1-BET button 34 once, i.e., in which a player has played a basic game by placing 1-BET. In addition, although three “JUPITER” symbols are rearranged on the payline L, no payment is paid out (see FIG. 5); and therefore, “0” is displayed at the number-of-payouts display portion 143. At the lower side of the display blocks 28, display is provided as to a payment which could be paid out if a player has placed 2-BETs or 3-BETs.

FIG. 8B shows a case in which a player has played a basic game by operating the maximum BET button 35. In other words, it is shown that a player has placed a basic game by placing 3-BETs which are a maximum number of BETs. In this case, three “JUPITER” symbols have been rearranged on the payline L; and therefore, 1,000 coins are paid out (see FIG. 5). Accordingly, the number-of-payouts display portion 143 displays the fact that 1,000 coins are paid out.

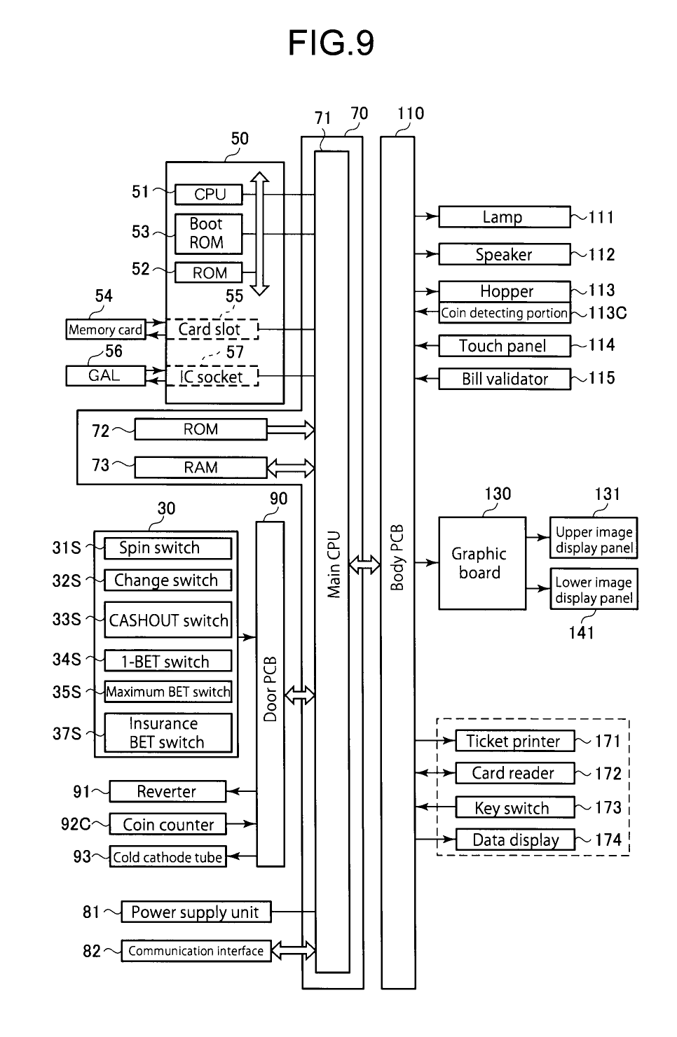

Next, an internal configuration of a gaming machine will be described. FIG. 9 is a block diagram depicting the internal configuration of the gaming machine. A gaming board 50 comprises: a CPU 51, a ROM 52, and a boot ROM 53, which are interconnected by means of an internal bus; a card slot 55 compatible with a memory card 54; and an IC socket 57 compatible with a GAL (Generic Array Logic) 56.

The memory card 54 is made of a nonvolatile memory, and stores game programs and game system programs. The game programs include: a program related to the progress of a game; a scatter prize determination program, and a program for executing effects by means of image or sound. The scatter prize determination program is a program for determining symbols rearranged in the display blocks 28 (as shown in FIG. 7, these symbols may be rephrased as code numbers corresponding thereto).

The abovementioned scatter prize determination program includes symbol-weighted data corresponding to a respective one of a plurality of payout rates (80%, 84%, 88%, for example). The symbol-weighted data is data for specifying random number values when symbols are determined for the display blocks 28, respectively.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the gaming machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like.

The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with: a main CPU 71 as a controller; a ROM 72; a RAM 73 as a memory; and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started.

The RAM 73 stores the data and programs that are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area of storing a counter for managing the number of games, the number of BETs, the number of payouts, the number of credits and the like; and an area of storing determined symbols (code numbers). In addition, in the embodiment, the RAM 73 stores: the scatter prize payment table which is shown in FIG. 5; and symbol arrangement corresponding to the number of BETs respectively (see FIGS. 6 and 7). Further, the RAM 73 stores a variety of flags, such as an insurance-effective flag indicative of whether or not an insurance function is effective, as well.

The communication interface 82 is for communicating with the external control device such as a server, through the communication line. Further, the motherboard 70 is connected with a later-described door PCB (Printed Circuit Board) 90 and a body PCB 110 by respective USBs. The motherboard 70 is also connected with a power supply unit 81.

When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71.

A control panel 30, a reverter 91, a coin counter 92C and a cold cathode tube 93 are connected to the door PCB 90.

The control panel 30 is provided with a spin switch 31S, a change switch 32S, a CASHOUT switch 33S, a 1-BET switch 34S and a maximum BET switch 35S which correspond to the aforementioned respective buttons. Each of the switches outputs a signal to the main CPU 71 upon detection of press of the button corresponding thereto by the player.

The coin counter 92C validates a coin inserted into the coin accepting slot 36 based on its material, shape and the like, and outputs a signal to the main CPU 71 upon detection of a valid coin. Invalid coins are discharged from a coin payout exit 15A.

The reverter 91 operates based on a control signal outputted from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal outputted from the main CPU 71.

The body PCB 110 is connected with the lamp 111, the speaker 112, the hopper 113, a coin detecting portion 113S, the touch panel 114, the bill validator 115, a graphic board 130, the ticket printer 171, the card reader 172, a key switch 173S and the data display 174.

The lamp 111 lights up based on a control signal outputted from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin payout exit 15A to the coin tray 15. The coin detecting portion 113S outputs a signal to the main CPU 71 upon detection of coins paid out by the hopper 113.

The touch panel 114 detects a place on the lower image display panel touched by the player's finger or the like, and outputs to the main CPU 71 a signal corresponding to the detected place.

Upon acceptance of a valid bill, the bill validator 115 outputs to the main CPU 71 a signal corresponding to the face amount of the bill.

The graphic board 130 controls display of images conducted by the respective upper image display panel 131 and lower image display panel 141, based on a control signal outputted from the main CPU 71. The graphic board 130 is provided with a VDP generating image data, a video RAM temporarily storing the image data generated by the VDP, and the like.

Based on a control signal outputted from the main CPU 71, the ticket printer 171 prints on a ticket a barcode representing encoded data of the number of credits stored in the RAM 73, date, the identification number of the gaming machine 1, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by the player.

The data display 174 displays data read by the card reader 172 and data inputted by the player through the keypad 173, based on a control signal outputted from the main CPU 71.

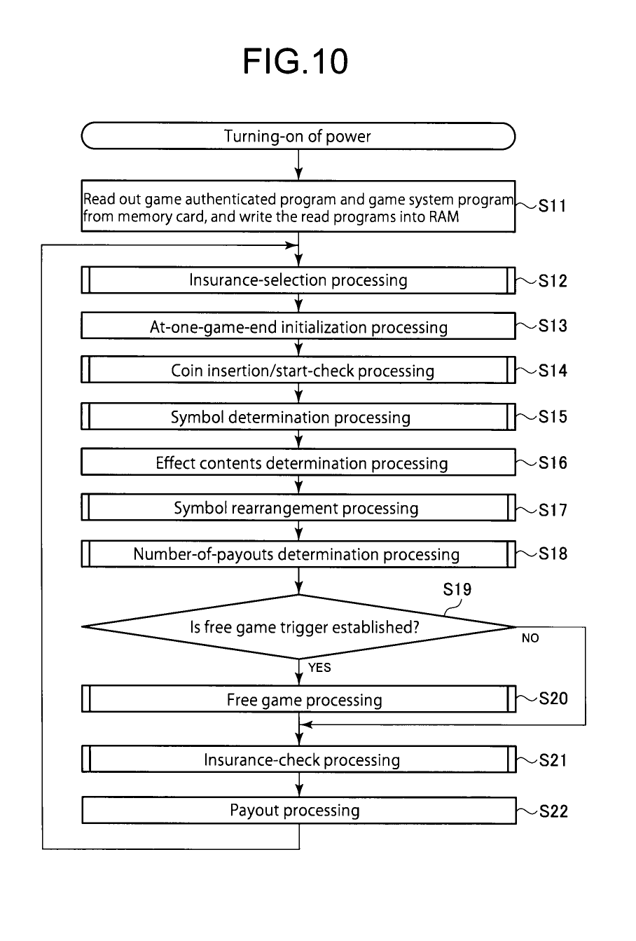

Next, with reference to FIGS. 10 to 19, a program to be executed by a gaming machine 1 will be described. A main CPU 71 of the gaming machine 1 prompts the play of a game to go forward by reading out and executing a program from a game program memory card 54.

First, main processing will be described. FIG. 10 is a flowchart showing a routine of the main processing of the gaming machine 1. When power is supplied to the gaming machine 1, the main CPU 71 reads out the authenticated game program and game system program from the memory card 54, via a gaming board 50, and then, writes the read programs in a RAM 73 (S11).

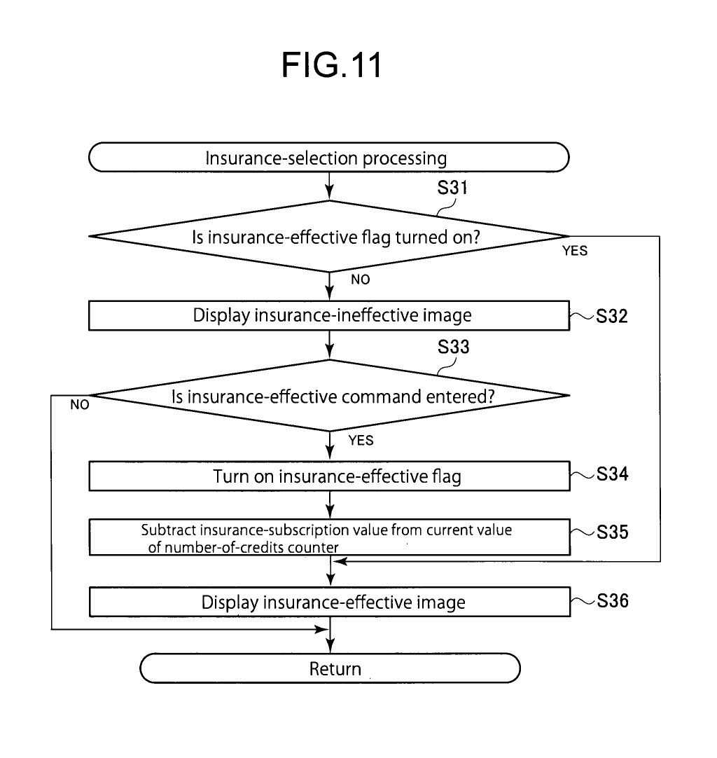

The main CPU 71 then conducts insurance-selection processing (S12). In this processing, a player is allowed to select whether or not to make insurance effective. The insurance-selection processing will be described later in detail with reference to FIG. 11.

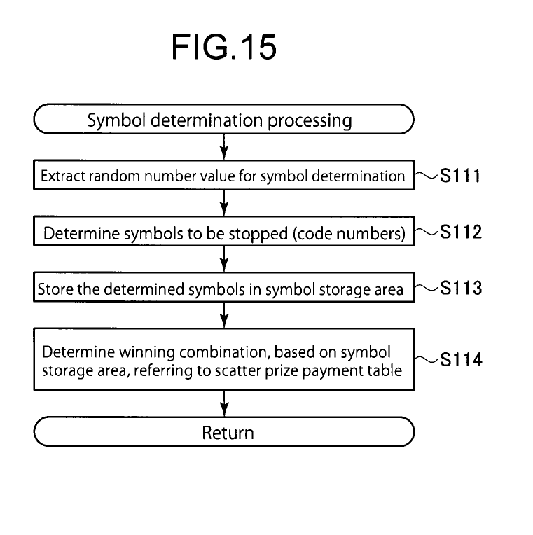

The main CPU 71 then conducts at-one-game-end initialization processing (S13). For example, data needed to be erased by game in the working areas of the RAM 73, such as the number of BETs and the symbols determined in S112 of FIG. 15 to be described later, is cleared.

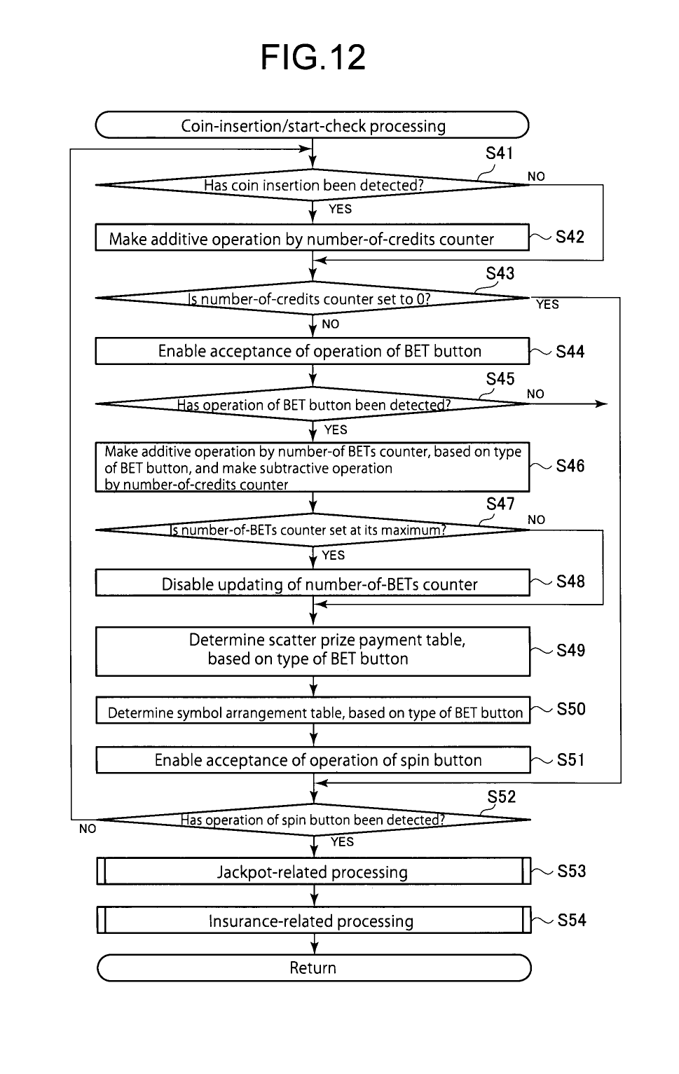

The main CPU 71 then conducts coin-insertion/start-check processing (S14). In the processing, check of inputs from the BET switch and the spin switch, for instance, is performed. In addition, the main CPU 71 determines a scatter prize payment table and a symbol arrangement table in accordance with the number of BETs. The coin-insertion/start-check processing will be described later with reference to FIG. 12.

The main CPU 71 then conducts symbol determination processing (S15). In this processing, symbols to be stopped (code numbers) are determined based on random number values for symbol determination. The symbol determination processing will be described later in detail with reference to FIG. 15.

The main CPU 71 then conducts effect contents determination processing (S16). Any of the effect contents is determined based on the random number values for effects, referring to symbols to be stopped, the symbols having been determined in the symbol determination processing of S15.

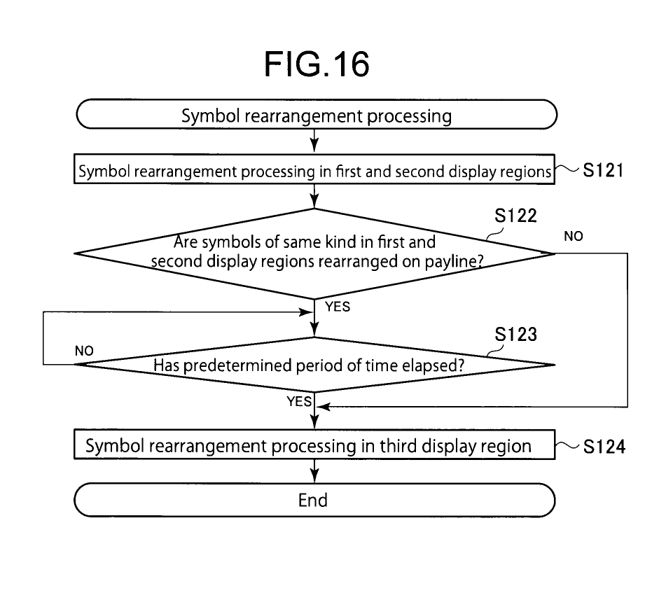

The main CPU 71 then conducts symbol rearrangement processing (S17). In this processing, the symbols to be stopped, having been determined in the symbol determination processing of S15, are automatically rearranged in display blocks 28 of the lower image display panel 141, respectively. The symbol rearrangement processing will be described later in detail with reference to FIG. 16.

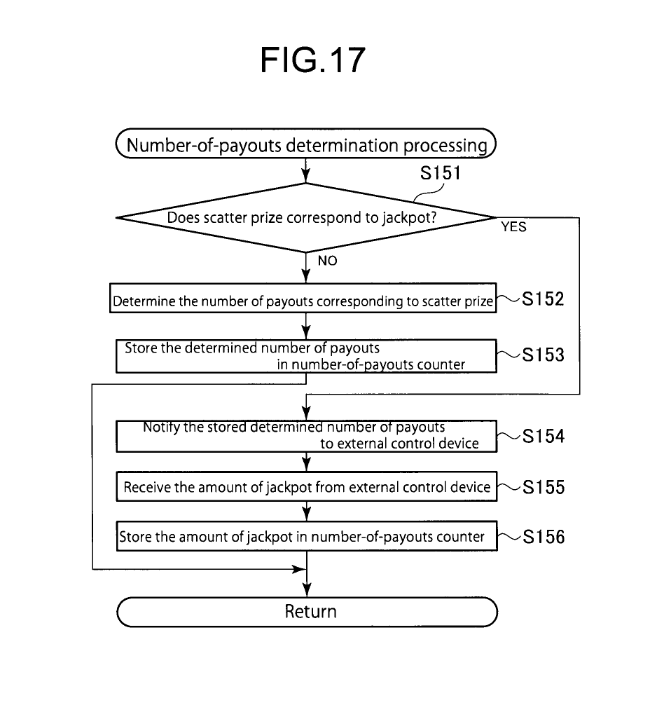

The main CPU 71 then conducts number-of-payouts determination processing (S18). In this processing, when the symbols having been rearranged on the payline L form a scatter prize, the number of payouts is determined according to a payment table of the scatter prize determined in S14 and a type of the established scatter prize, and then, the determined number of payouts is stored in a number-of-payouts counter provided in the RAM 73. The number-of-payouts determination processing will be described later in detail with reference to FIG. 17.

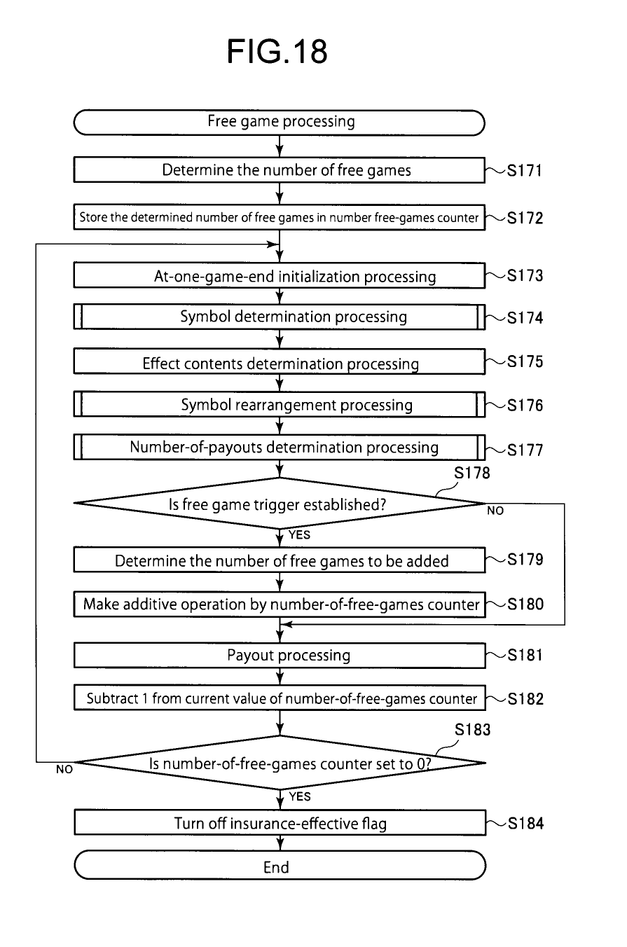

The main CPU 71 then determines whether or not a free game trigger has been established (S19). When determining that a free game trigger has been established, the main CPU 71 conducts free game processing (S20). This processing will be described later in detail with reference to FIG. 18. In the processing, a program associated with free game processing is read out, and this program is executed next time or subsequently, whereby a free game is started.

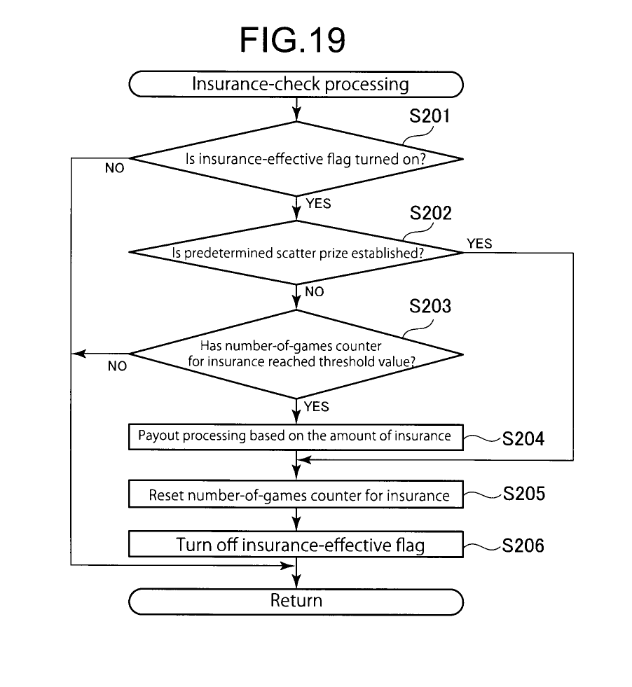

The main CPU 71 then conducts insurance-check processing (S21). When determining that a free game trigger is not established subsequent to the processing in S20, or alternatively, in S19, the main CPU 71 conducts insurance-check processing. In the case where an insurance-effective flag to be described later turns on, the main CPU 71 checks whether or not the number of games played while insurance is made effective has reached a threshold value. When determining that the number of games played while insurance is made effective has reached the threshold value, the main CPU 71 conducts payout of insurance. The insurance check processing will be described later in detail with reference to FIG. 19.

The main CPU 71 conducts payout processing (S22). In this processing, basically, the value stored in the number-of-payouts counter is added to a current value of a number-of-credits counter provided in the RAM 73. In addition, in this processing, the hopper 113 maybe controlled to be driven based on input from the CASHOUT switch 33S so as to discharge coins from the coin payout exit 15A. Further, the ticket printer 171 may be controlled to be driven so as to issue a ticket with a barcode. After the processing has been conducted, the routine reverts to S12.

Next, insurance-selection processing will be described. FIG. 11 is a flowchart showing a subroutine of insurance-selection processing. First, the main CPU 71 determines whether or not an insurance-effective flag turns on (S31). When determining that the insurance-effective flag fails to turn on, the main CPU 71 displays an insurance-ineffective image (S32). Here, the main CPU 71 transmits a command for displaying an insurance-effective image to a graphic board 130. Based on the command, the graphic board 130 generates an insurance-ineffective image, and then, displays the generated image on the lower image display panel 141. Alternatively, when determining that the insurance-effective flag turns on, the main CPU 71 displays an insurance-effective image (S36).

As the insurance-ineffective image, for example, an image showing “INSURANCE BET $1.00 TOUCH TO BET” is displayed. This image is an image for prompting the player to select whether or not to make the insurance effective, and notifying the player of the amount required for making the insurance effective. The player can input a command to make the insurance effective by touching a predetermined place on the touch panel 114.

Subsequently, the main CPU 71 determines whether or not an insurance-effective command input has been entered (S33). When the main CPU 71 determines that the insurance-effective command input has not been entered, the main CPU 71 shifts the processing to S31 with the insurance-effective flag turned off. On the other hand, when the main CPU 71 determines that the insurance-effective command input has been entered, the main CPU 71 turns the insurance-effective flag on (S34).

The main CPU 71 then subtracts the insurance-purchase amount from the number-of-credits counter (S35). In the present embodiment, an amount corresponding to, for example, one dollar is subtracted from the number-of-credits counter. The main CPU 71 then displays the insurance-effective image (S36). That is, subsequent to S35, or alternatively, when determining that the insurance-effective flag turns on in S31, the main CPU 71 displays an insurance-effective image.

As the insurance-effective image, for example, an image showing “INSURANCE CONTINUED WIN 200 CREDIT” is displayed. This image is an image informing the player that the insurance is effective, and that the value of “200” is to be added to the number-of-credits counter when the insurance condition is satisfied. After the processing has been conducted, the insurance-selection processing is completed.

Next, coin-insertion/start-check processing is described. FIG. 12 is a flowchart showing a subroutine of coin insertion/start-check processing. First, the main CPU 71 determines whether or not coin insertion has been detected by a coin counter 92C (S41). When determining that the insertion of a coin has been detected, the main CPU 71 makes an addition to a current value of the number-of-credits counter (S42). In addition to the insertion of a coin, the main CPU 71 may determine whether or not insertion of a bill has been detected by the bill validator 115, and when determining that the insertion of a bill has been detected, the main CPU 71 may add a value according to the bill to the current value of the number-of-credits counter.

The main CPU 71 then determines whether or not the number-of-credits counter is set to 0 (S43). That is, subsequent to S42, or alternatively, when determining that no coin insertion has been detected in S41, the main CPU 71 determines whether or not the number-of-credits counter is set to 0. When the main CPU 71 determines that the number-of-credits counter is not set to 0, the main CPU 71 permits operation acceptance of the BET buttons (S44).

The main CPU 71 then determines whether or not operation of a BET button has been detected by a BET switch (S45). When determining that operation of the BET button has been detected by the BET switch, the main CPU 71 makes an addition to a current value of the number-of-BETs counter provided in the RAM 73 based on a BET button type, and makes a subtraction from that of the number-of-BETs counter (S46).

Next, the main CPU 71 determines whether or not the number-of-BETs counter is set at its maximum (S47). When determining that the number-of-BETs counter is set at its maximum, the main CPU 71 disables updating of the number-of-BETs counter (S48).

The main CPU 71 then conducts processing of determining a scatter prize payment table, based on a BET button type (S49). That is, subsequent to S48, or alternatively, when determining that the number-of-BETs counter is not set at its maximum in S47, the main CPU 71 conducts the processing. Specifically, the main CPU 71 determines a scatter prize payment table, which corresponds to the BET button type detected in S45, from among the scatter prize payment tables shown in FIG. 5.

The main CPU 71 then conducts processing of determining a symbol arrangement table, based on a BET button type (S50). Specifically, the main CPU 71 determines a symbol arrangement table which corresponds to the BET button type detected in S45, from among the three symbol arrangement tables stored in the RAM 73 (see FIGS. 6 and 7).

Next, the main CPU 71 permits operation acceptance of a spin button (S51). The main CPU 71 then determines whether or not operation of the spin button 31 has been detected (S52). That is, subsequent to S51, when determining that operation of a BET button has been detected in S45, or alternatively, when determining that the number-of-credits counter is 0 in S43, the main CPU 71 determines whether or not operation of the spin button 31 has been detected. When the main CPU 71 determines that operation of the spin button has not been detected, the routine reverts to S41.

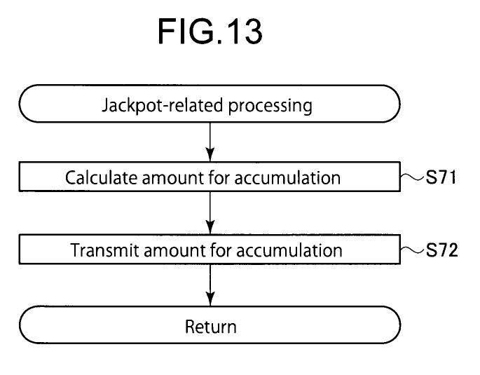

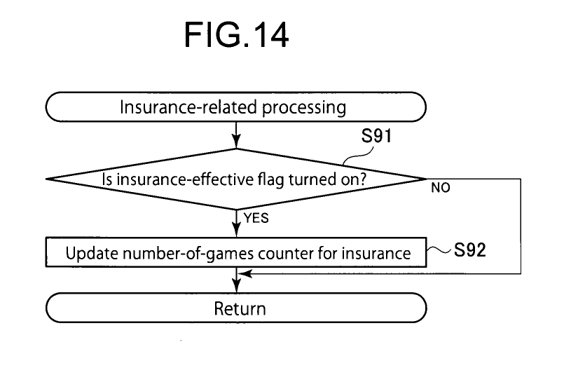

Alternatively, when determining that operation of the spin button 31 has been detected, the main CPU 71 conducts jackpot-related processing (S53). The jackpot-related processing will be described later in detail with reference to FIG. 13. Next, the main CPU 71 conducts insurance-related processing (S54). The insurance-related processing will be described in detail with reference to FIG. 14. After this processing has been conducted, coin-insertion/start-check processing is completed.

Next, jackpot-related processing will be described. FIG. 13 is a flowchart showing a subroutine of jackpot-related processing. First, the main CPU 71 calculates the amount for accumulation (S71). A product of the value of the number-of-BETs counter and a preset accumulation ratio is obtained, and the amount for accumulation to the amount of jackpot is then calculated.

The main CPU 71 then transmits the calculated amount for accumulation to an external control device (S72). Upon reception of the amount for accumulation, the external control device updates the amount of jackpot. After the processing has been conducted, the jackpot-related processing is completed.

Next, insurance-related processing will be described. FIG. 14 is a flowchart showing a subroutine of insurance-related processing. First, the main CPU 71 determines whether or not an insurance-effective flag turns on (S91). The insurance-effective flag is set to ON if an operation relative to a touch panel 114 by a player has been detected in S34 of the insurance-selection processing described with reference to FIG. 11.

When determining that the insurance-effective flag fails to turn on, the main CPU 71 completes insurance-related processing. On the other hand, when determining that the insurance-effective flag turns on, the main CPU 71 updates a number-of-games counter for insurance, provided in the RAM 73 (S92). The number-of-games counter for insurance is a counter for managing the number of games played when and after the insurance-effective flag has been turned on, and is added on one-by-one count basis in the processing of S92. After this processing has been conducted, insurance-related processing is completed.

Next, symbol determination processing will be described. FIG. 15 is a flowchart showing a subroutine of symbol determination processing. First, the main CPU 71 extracts random number values for symbol determination (S111). Specifically, the main CPU 71 selects three random number values, each of which corresponds to a respective one of symbol arrays (3 columns), from among the numeric value range of 0 to 255, by executing a program for generating random numbers, included in a symbol determination program. The embodiment describes a case in which random numbers are generated on the program (a case of employing so called software random numbers). However, in the present invention, a random number generator is provided in advance, whereby random numbers may be extracted from the random number generator (so called hardware random numbers may be employed).

The main CPU 71 then determines symbols to be stopped (code numbers) (see FIG. 7) (S112). Code No. of symbol arrays corresponds to code No. of symbol to be stop-displayed in each display block 28. The main CPU 71 determines a prize by determining code No. of each symbol array. As shown in FIG. 7, for example, when 2-BETs are placed, if the main CPU 71 has determined code Nos. of symbols to be “02, “07”, “09”, respectively, the prize is determined to be “JUPITER”.

Next, the main CPU 71 stores the determined symbols to be stopped in a symbol storage area provided in the RAM 73 (S113). The main CPU 71 then determines whether or not a scatter prize is established, based on the symbol storage area, referring to the scatter prize payment table (see FIG. 5) that is determined in S49 shown in FIG. 12 (S114). After this processing has been conducted, symbol determination processing is completed.

Next, symbol rearrangement processing will be described. FIG. 16 is a flowchart showing a subroutine of symbol rearrangement processing. First, the main CPU 71 conducts symbol rearrangement processing in the first and second display regions (S121). Specifically, the main CPU 71 reads symbols to be stopped (code numbers) stored in the RAM 73 in S113 shown in FIG. 15, and stop-displays (rearranges) the read corresponding symbols sequentially in the first and second display regions.

The main CPU 71 then determines whether or not symbols in the first and second display regions are of same kind (S122). In the case of determining that the symbols in the first and second display regions are of same kind, the main CPU 71 determines whether or not a predetermined period of time has elapsed after the second display region has been stop-displayed (rearranged) (S123).

Next, when determining that the predetermined period of time has elapsed in S123 and when determining that the symbols in the first and second display regions rearranged on the payline are not of same kind in S122, the main CPU 71 conducts symbol rearrangement processing in the third display region (S124). In this processing, as in the processing of S121, the main CPU 71 reads symbols to be stopped (code numbers) stored in the RAM 73, and stop-displays (rearranges) the read corresponding symbols in the third display region. When this processing completes, symbol rearrangement processing is also completed.

Next, number-of-payouts determination processing will be described. FIG. 17 is a flowchart showing a subroutine of the number-of-payouts determination processing. First, the main CPU 71 determines whether or not a scatter prize corresponds to a jackpot (S151). When determining that the scatter prize fails to correspond to a jackpot, the main CPU 71 determines the number of payouts corresponding to the scatter prize (S152). For example, if three “SUN” symbols have been stop-displayed on a payline, 0, 100, or 200 coins are paid out when a basic game has been performed while a player places 1-BET, 2-BETs, or 3-BETs (see FIG. 5). When the game is lost, “0” is determined to be the number of payouts. Next, the main CPU 71 stores the determined number of payouts in a number-of-payouts counter (S153). After this processing has been conducted, the number-of-payouts determination processing is completed.

When the main CPU 71 determines that the scatter prize is the jackpot, the main CPU 71 notifies the external control device of the winning of the jackpot (step S154). Upon reception of the notification, the external control device that controls the plurality of gaming machines 1 transmits to the gaming machines 1 the amount of jackpot having updated up to that time. At this time, while a part (e.g. 80%) of the amount of jackpot may be the subject of transmission, the rest may be carried over in preparation for the upcoming establishment of the jackpot trigger.

The main CPU 71 then receives the amount of jackpot from the external control device (step S155). The main CPU 71 then stores the received amount of jackpot into the number-of-payouts counter (step S156). After the processing has been conducted, the number-of-payouts determination processing is completed.

Next, free game processing will be described. FIG. 18 is a flowchart showing a subroutine of free game processing. First, the main CPU 71 determines the number of free games (S171). In the embodiment, a plurality of numbers “50”, “70”, and “100”, for example, are specified as the number of free games, and any one of them is determined.

The main CPU 71 then stores the determined number of free games in a number-of-free-games counter which is provided in the RAM 73 (S172).

Next, the main CPU 71 conducts at-one-game-end initialization processing, as in the processing of S13 shown in FIG. 10 described previously (S173). The main CPU 71 then conducts the symbol determination processing shown in FIG. 15 described previously (S174). The main CPU 71 then conducts the effect contents determination processing, as in the processing of S16 shown in FIG. 10 described previously (S175). Further, the main CPU 71 conducts the symbol rearrangement processing shown in FIG. 16 (S176). Furthermore, the main CPU 71 conducts the number-of-payouts determination processing shown in FIG. 17 described previously (S177).

The main CPU 71 then determines whether a free game trigger has been established (S178). When determining that the free game trigger has been established, the main CPU 71 determines the number of free games to be added (S179). The number of free games is determined in such a manner that is similar to that of the processing of S171 described previously. The main CPU 71 then adds the determined number of free games to a current value of the number-of-free-games counter (S180).

Next, the main CPU 71 conducts payout processing (S181). Subsequent to the processing of S180, or alternatively, when determining that a free game trigger is not established in S178, the main CPU 71 conducts payout processing. In this processing, the main CPU 71 adds a value of the number-of-payouts counter, which is stored in the number-of-payouts determination processing of S177, to a current value of the number-of-payouts counter for free game. The number-of-payout counter for free game is for managing a total number of payouts, determined in a free game.

After free game processing has completed, the value stored in the number-of-payouts counter for free game is added to a current value of the number-of-credits counter provided in the RAM 73, during the payout processing of S22 in FIG. 10 described previously. Namely, a total number of payouts determined through a free game is paid out in all. Coins may be ejected from the coin payout exit 15A, or alternatively, a ticket with a barcode may be issued.

Next, the main CPU 71 subtracts 1 from a current value of the number-of-free-games counter (S182). The main CPU 71 then determines whether or not the number-of-free-games counter is set to 0 (S183). When the main CPU 71 determines that the number-of-free games counter is not set to 0, the routine reverts to S173. On the other hand, when determining that the number-of-free-games counter is set to 0, the main CPU 71 turns off an insurance-effective flag (S184). Afterwards, free game processing is completed. After free game processing has been completed, the routine reverts to S21 in which the main control processing shown in FIG. 10 described previously is to be performed.

Next, insurance-check processing will be described. FIG. 19 is a flowchart showing a subroutine of insurance-check processing.

First, the main CPU 71 determines whether or not an insurance-effective flag turns on (S201). When determining that the insurance-effective flag fails to turn on, the main CPU 71 completes insurance-check processing.

When determining that the insurance-effective flag turns on, the main CPU 71 then determines whether or not a predetermined scatter prize has been established (S202). In the embodiment, a “free game trigger” and a “jackpot” are the subject of the predetermined scatter prize. Specifically, a free game trigger is established in the case where three “EARTH” symbols are stop-displayed (rearranged) on the payline L.

When determining that a predetermined scatter prize is not established, the main CPU 71 determines whether or not the number-of-games counter for insurance has reached a threshold value (100 times, for example) (S203). When determining that the number-of-games counter for insurance fails to reach the threshold value, the main CPU 71 completes insurance-check processing.

When determining that the number-of-games counter for insurance has reached a threshold value, the main CPU 71 conducts payout processing, based on the amount of insurance (S204). In the embodiment, a predetermined amount of insurance (200, for example) is specified, and this specified value is added to a current value of the number-of-credits counter.

Subsequent to 204, or alternatively, when determining that a predetermined winning combination has established in S202, the main CPU 71 resets the number-of-games counter for insurance (S205). Next, the main CPU 71 turns off the insurance-effective flag (S206). After this processing has been conducted, insurance-check processing is completed.

While the foregoing examples described a case of displaying a total of 9 symbols of 3 columns×3 lines, the symbol display in the present invention can be applied to a variety of forms, such as 5 columns×4 lines, without being limitative thereto. In addition, while the foregoing examples described a case of scroll-displaying symbols in each display block column, symbols may be scroll-displayed individually. Further, the third display region displayed after the predetermined period of time has elapsed after the second display region has been rearranged, the present invention is not limitative thereto.

While the foregoing examples described scroll-displaying of symbols employing a liquid crystal display device or the like, the present invention is not limitative thereto. If mechanical reels are employed, symbols drawn on surfaces of the mechanical reels may be displayed.

Although the embodiments of the present invention were described above, they were just illustrations of specific examples, and hence do not particularly restrict the present invention. A specific configuration of each step and the like is appropriately changeable in terms of design. Further, the effects described in the embodiments of the present invention are just recitations of the most suitable effects generated from the present invention. The effects of the present invention are thus not limited to those described in the embodiments of the present invention.

What is claimed is:

1. A gaming machine, comprising:
(i) an input device for inputting a number of BETs;
(ii) a memory for storing plural kinds of symbols for displaying plural kinds of symbol combinations including a specific symbol combination which is not paid when a first number of BETs is placed and which is paid when a second number of BETs is placed;
(iii) a display for displaying the plural kinds of symbols; and
(iv) a controller, the controller being configured to perform processing of:
(a-1) in a case where the number of BETs input by the input device is the first number of BETs, determining arrangement of the plural kinds of symbols so that the specific symbol combination is displayed on the display more frequently than when the second number of BETs is placed;
(a-2) rearranging the plural kinds of symbols on the display in accordance with a result of the determination of (a-1);
(a-3) awarding a payment-free prize is made, in a case where the specific symbol combination is rearranged on the display as a result of the processing of (a-2);
(b-1) in a case where the number of BETs input by the input device is the second number of BETs, determining arrangement of the plural kinds of symbols so that the specific symbol combination is displayed on the display less frequently than when the first number of BETs is placed;
(b-2) rearranging the plural kinds of symbols on the display in accordance with a result of the determination of (b-1); and
(b-3) awarding a payment-accompanying prize in a case where the specific symbol combination is rearranged on the display as a result of the processing of (b-2).

2. The gaming machine according to claim 1, wherein the first number of BETs is smaller than the second number of BETs.

3. The gaming machine according to claim 1, wherein the specific symbol combination is paid when the second number of BETs is placed, and is paid when a third number of BETs, which is larger than the first number of BETs and smaller than the second number of BETs, is placed, the controller being configured to perform processing of:
(c-1) in a case where the number of BETs input by the input device is the third number of BETs, determining arrangement of the plural kinds of symbols so that the specific symbol combination is displayed on the display less frequently than when the first number of BETs is placed and is displayed more frequently than when the second number of BETs is placed;
(c-2) rearranging the plural kinds of symbols on the display in accordance with a result of the determination of (c-1); and
(c-3) awarding the payment-accompanying prize in a case where the specific symbol combination is rearranged on the display as a result of the processing of (c-2).

4. A gaming machine, comprising:
(i) an input device for inputting a number of BETs;
(ii) a memory for storing plural kinds of symbols for displaying plural kinds of symbol combinations including a specific symbol combination which is not paid when a first number of BETs is placed and which is paid when a second number of BETs, which is larger than the first number of BETs, and a third number of BETs, which is smaller than the second number of BETs and larger than the first number of BETs, is placed;
(iii) a display for displaying the plural kinds of symbols; and
(iv) a controller, the controller being configured to perform processing of:
(a-1) in a case where the number of BETs input by the input device is the first number of BETs, determining arrangement of the plural kinds of symbols so that the specific symbol combination is displayed on the display more frequently than when the second number of BETs is placed;
(a-2) rearranging the plural kinds of symbols on the display in accordance with a result of the determination of (a-1);
(a-3) awarding a payment-free prize in a case where the specific symbol combination is rearranged on the display as a result of the processing of (a-2);
(b-1) in a case where the number of BETs input by the input device is the second number of BETs, determining arrangement of the plural kinds of symbols so that the specific symbol combination is displayed on the display less frequently than when the first number of BETs is placed;
(b-2) rearranging the plural kinds of symbols on the display in accordance with a result of the determination of (b-1);
(b-3) awarding a payment-accompanying prize in a case where the specific symbol combination is rearranged on the display as a result of the processing of (b-2);
(c-1) in a case where the number of BETs input by the input device is the third number of BETs, determining arrangement of the plural kinds of symbols so that the specific symbol combination is displayed on the display less frequently than when the first number of BETs is placed and is displayed more than when the second number of BETs is placed;
(c-2) rearranging the plural kinds of symbols on the display in accordance with a result of the determination of (c-1); and
(c-3) awarding the payment-accompanying prize in a case where the specific symbol combination is rearranged on the display as a result of the processing of (c-2).

5. A gaming machine control method, comprising the steps of:
(a-1) in a case where the number of BETs input by the input device is the first number of BETs, determining arrangement of the plural kinds of symbols so that the specific symbol combination is displayed on the display more frequently than when the second number of BETs larger than the first number of BETs is placed;
(a-2) rearranging the plural kinds of symbols on the display in accordance with a result of the determination of (a-1);
(a-3) awarding a payment-free prize is made, in a case where the specific symbol combination is rearranged on the display as a result of the processing of (a-2);
(b-1) in a case where the number of BETs input by the input device is the second number of BETs, determining arrangement of the plural kinds of symbols so that the specific symbol combination is displayed on the display less frequently than when the first number of BETs is placed;
(b-2) rearranging the plural kinds of symbols on the display in accordance with a result of the determination of (b-1); and
(b-3) awarding a payment-accompanying prize in a case where the specific symbol combination is rearranged on the display as a result of the processing of (b-2).

6. The gaming machine control method according to claim 5, wherein the specific symbol combination is paid when the second number of BETs is placed and is paid when a third number of BETs, which is larger than the first number of BETs and is smaller than the second number of BETs, is placed, the method further comprising the steps of:
(c-1) in a case where the number of BETs input by the input device is the third number of BETs, determining arrangement of the plural kinds of symbols so that the specific symbol combination is displayed on the display less frequently than when the first number of BETs is placed and is displayed more than when the second number of BETs is placed;
(c-2) rearranging the plural kinds of symbols on the display in accordance with a result of the determination of (c-1); and
(c-3) awarding the payment-accompanying prize in a case where the specific symbol combination is rearranged on the display as a result of the processing of (c-2).
